(19) United States
(12) Patent Application Publication
(10) Pub. No.: US 2026/0017917 A1
(43) Pub. Date: Jan. 15, 2026

(54) FEATURE POINT PROCESSING DEVICE AND FEATURE POINT PROCESSING METHOD

(71) Applicants: DENSO CORPORATION, Kariya-city (JP); TOYOTA JIDOSHA KABUSHIKI KAISHA, Toyota-shi, Aichi-ken (JP); MIRISE Technologies Corporation, Nisshin-shi (JP)

(72) Inventor: NAOKI OOARATA, Nisshin-shi (JP)

(21) Appl. No.: 19/229,273

(22) Filed: Jun. 5, 2025

(30) Foreign Application Priority Data
Jul. 10, 2024 (JP) 2024-110770

(51) Int. Cl. G06V 10/44; G06V 10/52; G06V 10/75

(52) U.S. Cl. CPC G06V 10/44; G06V 10/52; G06V 10/751

(57) ABSTRACT

Multiple hierarchy images are generated to have sizes that are obtained by reducing a process target image by multiple reduction ratios using the process target image acquired by a camera mounted on a mobile object. A feature point detection process is executed to detect multiple feature points from the hierarchy images. Some of the feature points are selected and excluded as an exclusion feature point such that, among the feature points, one of the feature points having a pixel accuracy exceeding an allowance value is selected as the exclusion feature point. The pixel accuracy is an accuracy per pixel determined according to the reduction ratio of each hierarchy image.

### CROSS REFERENCE TO RELATED APPLICATION

The present application claims the benefit of priority from Japanese Patent Application No. 2024-110770 filed on Jul. 10, 2024. The entire disclosure of the above application is incorporated herein by reference.

### TECHNICAL FIELD

This disclosure relates to a feature point processing device that executes a feature point exclusion process and a feature point processing method.

### BACKGROUND

A conceivable technique teaches a technique for detecting multiple feature points from an image and using the multiple feature points to estimate the position of a mobile object. Position estimation techniques require scale invariance, which is a property that enables accurate detection of target object features even when the scale of the target object changes. To ensure scale invariance, the feature point detection process uses a technique that generates multiple pyramid type hierarchy images and detects feature points from each of the multiple hierarchy images. The hierarchy image is also defined as a “pyramid image” or a “reduction image.

By using multiple hierarchy images to detect feature points, it is possible to detect and track feature points that are robust to changes in camera and environmental scales. For example, when the camera is approaching or moving away from a target object, the pyramid image process can detect and track the feature points with appropriate resolution.

### SUMMARY

According to an example, multiple hierarchy images are generated to have sizes that are obtained by reducing a process target image by multiple reduction ratios using the process target image acquired by a camera mounted on a mobile object. A feature point detection process is executed to detect multiple feature points from the hierarchy images. Some of the feature points are selected and excluded as an exclusion feature point such that, among the feature points, one of the feature points having a pixel accuracy exceeding an allowance value is selected as the exclusion feature point. The pixel accuracy is an accuracy per pixel determined according to the reduction ratio of each hierarchy image.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing the configuration of the position estimation device for a mobile object in the first embodiment;

FIG. 2 is a diagram for explaining an example of multiple hierarchy images;

FIG. 3 is a diagram for explaining an example of multiple feature points;

FIG. 4 is a diagram for explaining the horizontal resolution and vertical resolution of the hierarchy image;

FIG. 5 is a diagram showing the number of pixels and pixel accuracy of each hierarchy image in the first embodiment;

FIG. 6 is a diagram for explaining the hierarchy image that are to be excluded in the first embodiment;

FIG. 7 is a flowchart showing the procedure of the position estimation process in the first embodiment;

FIG. 8 is a block diagram showing the configuration of the position estimation device for a mobile object in the second embodiment;

FIG. 9 is a diagram for explaining an example of a distance estimation method for feature points by road surface estimation;

FIG. 10 is a diagram for explaining a relationship between the distance of a feature point and a pixel accuracy in the second embodiment;

FIG. 11 is a diagram for showing the features that are to be excluded in the second embodiment;

FIG. 12 is a flowchart showing the procedure of the position estimation process in the second embodiment;

FIG. 13 is a block diagram showing the configuration of the position estimation device for a mobile object in the third embodiment;

FIG. 14 is a diagram for explaining a displacement allowance value in the third embodiment;

FIG. 15 is a diagram for showing the features that are to be excluded in the third embodiment; and

FIG. 16 is a flowchart showing the procedure of the position estimation process in the third embodiment.

### DETAILED DESCRIPTION

Among feature points detected in an image, a feature point that is located in the distance tend to have a larger error per pixel. Among multiple hierarchy images, this error value is larger for a hierarchy image with a larger reduction ratio and smaller size, resulting in a larger error regarding the position of a distant feature point. As a result, the reliability of the positions and postures of feature points in three dimensional coordinates becomes low, which deteriorates the accuracy of feature point tracking between image frames and the accuracy of position estimation of a mobile object. Therefore, a technique that can exclude feature points with low accuracy is desired.

According to one aspect of the present embodiments, a feature point processing device is provided. The feature point processing device includes: a hierarchy image generation unit that generates a plurality of hierarchy images having sizes by reducing a size of a processing target image by a plurality of reduction ratios, respectively, using the processing target image acquired by a camera mounted on a mobile object; a feature point detection unit that executes a feature point detection process to detect a plurality of feature points from the plurality of hierarchy images; and a feature point exclusion processing unit that selects and excludes some of the plurality of feature points as an exclusion feature point. The feature point exclusion processing unit selects, among the plurality of feature points, one of the feature points having a pixel accuracy exceeding an allowance value as the exclusion feature point. The pixel accuracy is an accuracy per pixel determined according to the reduction ratio of each hierarchy image.

According to this feature point processing device, it is possible to exclude feature points with low accuracy and use only feature points with high accuracy.

### A. First Embodiment

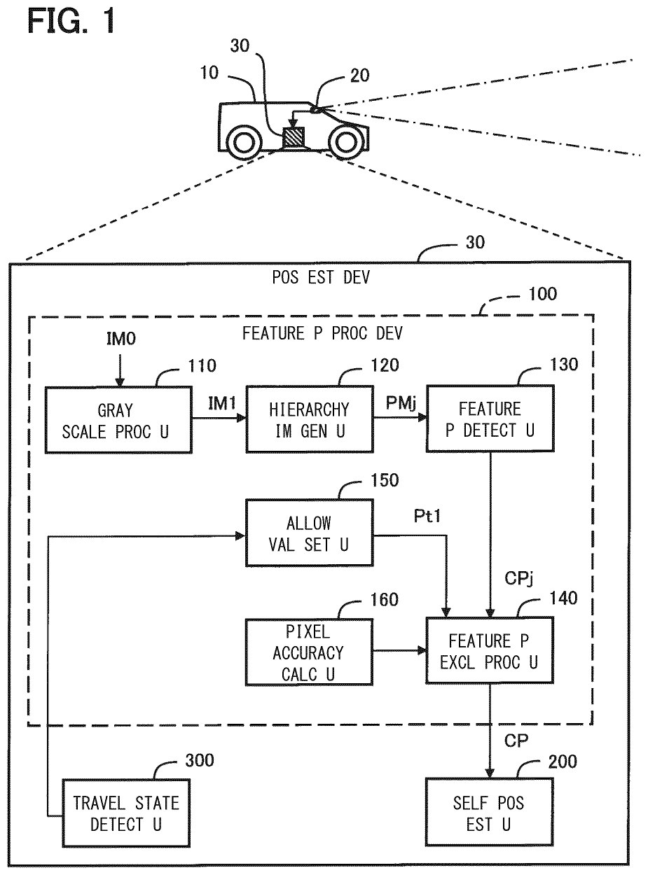

As shown in FIG. 1, the position estimation unit 30 of the first embodiment executes the process of estimating the self-position of the mobile object 10 using images captured by the camera 20 mounted on the mobile object 10. The position estimation unit 30 includes a feature point processing device 100 that extracts a plurality of feature points using the frame image IM0 captured by the camera 20, a self-position estimation unit 200 that estimates the self-position of the mobile object 10 using the plurality of feature points, and a travel state detection unit 300 that detects the travel state of the mobile object 10.

The camera 20 may be a monocular camera, or a stereo camera or a RGBD camera including a RGB camera and a Depth camera. In the present embodiment, a monocular camera for color imaging is used.

The position estimation unit 30 can be realized as an ECU (i.e., Electronic Control Unit) with a processor and a memory. The function of each part of the position estimation unit 30 can be realized by a processor executing a computer program stored in a memory. Alternatively, some or all of each part may be realized by a hardware circuit.

The feature point processing device 100 includes a grayscale processing unit 110, a hierarchy image generation unit 120, a feature point detection unit 130, a feature point exclusion processing unit 140, an allowance value setting unit 150, and a pixel accuracy calculation unit 160.

The grayscale processing unit 110 executes a grayscale process on the frame image IM0, which is a full-color image acquired by the image capture of the camera 20. The grayscale process is the process of converting a full-color image into, for example, an 8-bit grayscale image (i.e., multi-grayscale gray image). In this embodiment, the grayscale image is also referred to as “a process target image IM1”. The process target image IM1 is the image used for the feature point detection process.

When a RAW image is supplied from the camera 20 to the feature point processing device 100, a full-color frame image IM0 may be acquired by executing a preprocess such as a de-mosaic process, a noise remove process, and a distortion correction process on the RAW image. The de-mosaic process is the process of generating a full-color image in which each pixel has an RGB pixel value by complementing the pixel values of R, G, and B pixels that are arranged in a checkerboard pattern in the RAW image.

The hierarchy image generation unit 120 uses the process target image IM1 to generate a plurality of hierarchy images PMj, each having the size by reducing the size of the process target image IM1 by a plurality of reduction ratios.

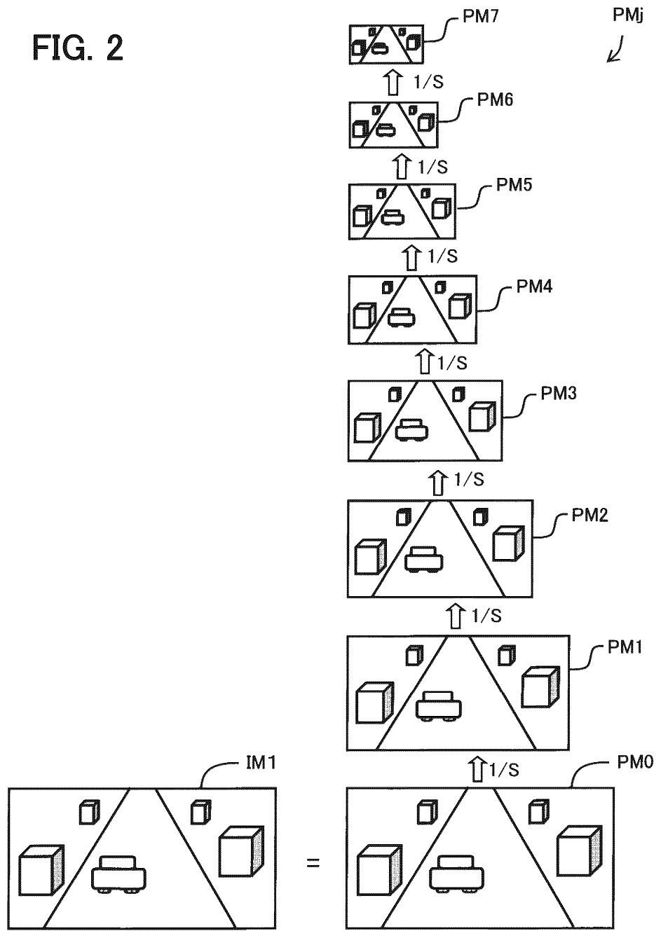

As shown in FIG. 2, the process target image IM1 is used as it is as the lowest level hierarchy image PM0. When j is an integer greater than or equal to 1, the j-th hierarchy image PMj is prepared by reducing the (j−1)-th hierarchy image PMj−1 by a scale factor S. Therefore, the j-th hierarchy image PMj is the image in which the process target image IM1 is reduced by a reduction ratio of 1/Si. The scale factor S is set to a value greater than 1. In the example in FIG. 2, a constant scale factor S is used to generate multiple pyramid type hierarchy images PM0-PM7, but it is not necessary to use a constant scale factor S. It is sufficient to generate multiple hierarchy images PMj, each having the size by reducing the size of the process target image IM1 by multiple reduction factors. If the lowest hierarchy image PM0 is included, the variable j, which distinguishes the hierarchy image PMj, is an integer greater than or equal to 0.

The feature point detection unit 130 executes a feature point detection process to detect multiple feature points from multiple hierarchy images PMj.

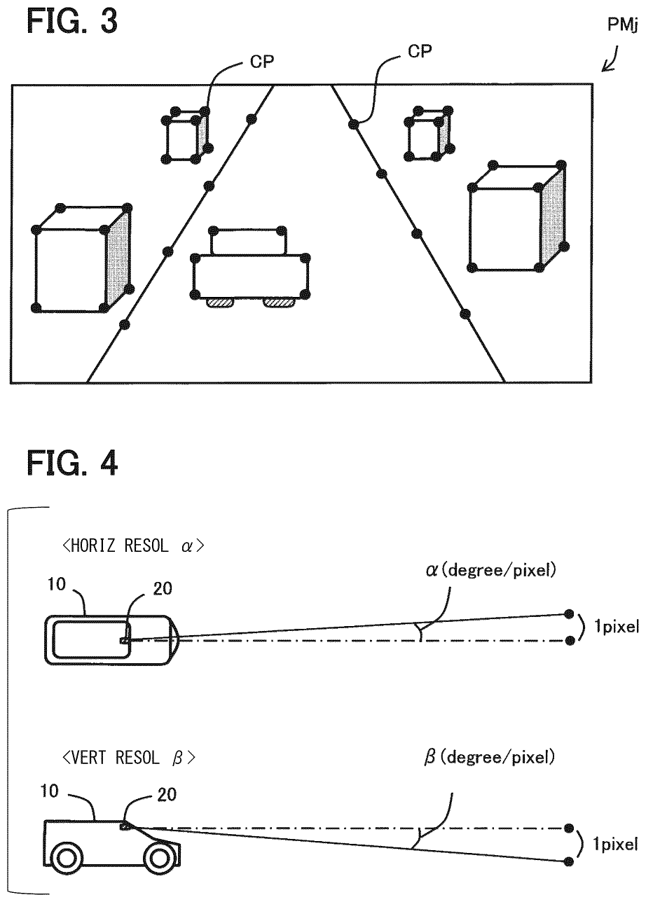

As shown in FIG. 3, multiple feature points CP are detected from individual hierarchy images PMj. In this embodiment, FAST (i.e., Features from Accelerated Segment Test) is used as the detection algorithm for feature points. Alternatively, other feature point detection algorithms such as Harris corner detection, Shi-Tomashi corner detection, GFTT, SIFT, AKAZE, ORB, and the like may be used.

The feature point exclusion processing unit 140 selects and excludes some of the multiple feature points CP as exclusion feature points. The allowance value setting unit 150 sets an allowance value for determining an exclusion feature point. The allowable value may be a fixed value, or it may be changed according to the travel state of the mobile object 10 detected by the travel state detection unit 300. The pixel accuracy calculation unit 160 executes the process of calculating a pixel accuracy, which is the accuracy per pixel. As described below, the pixel accuracy is determined by the reduction ratio of each hierarchy image PMj. The processing details of the feature point exclusion processing unit 140, the allowance value setting unit 150, and the pixel accuracy calculation unit 160 are described below.

As shown in FIG. 4, in the first embodiment, in each individual hierarchy image PMj, the horizontal resolution α is calculated according to the horizontal view angle of the camera 20, and the vertical resolution β is calculated according to the vertical view angle. These resolutions α and β are the angular resolution per pixel and are used as pixel accuracy in the first embodiment.

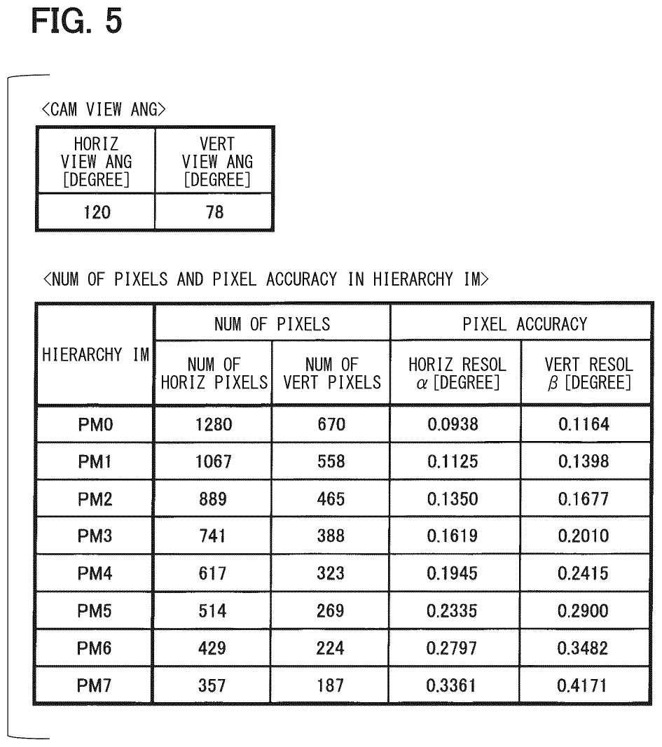

As shown in FIG. 5, the number of horizontal and vertical pixels in each hierarchy image PMj is determined according to the respective reduction ratio. The pixel accuracy calculation unit 160 calculates the horizontal resolution α and the vertical resolution β according to the number of horizontal and vertical pixels in each hierarchy image PMj. The horizontal resolution α is a value obtained by dividing the horizontal view angle of view by the number of horizontal pixels. The vertical resolution β is a value obtained by dividing the vertical view angle by the number of vertical pixels. In the embodiments, “horizontal” and “vertical” refer to the horizontal and vertical directions in the image plane of the camera 20, respectively.

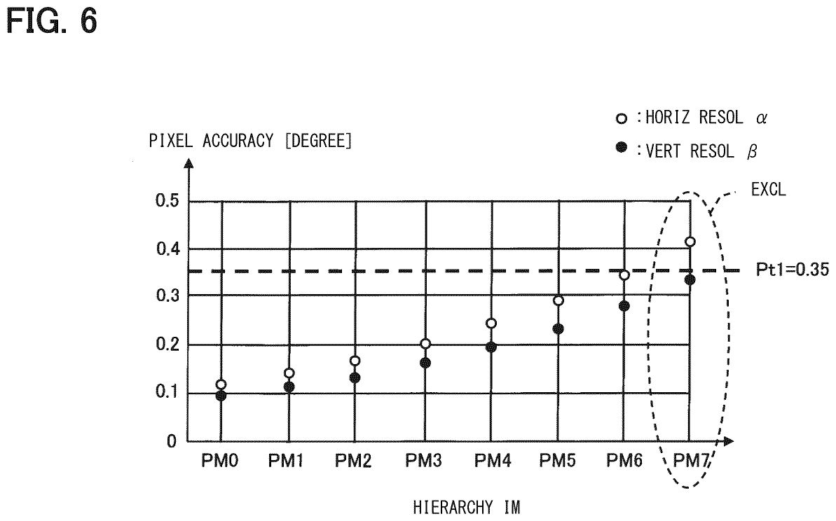

As shown in FIG. 6, the horizontal resolution α and the vertical resolution β as the pixel accuracy are determined for each hierarchy image PMj. That is, all feature points detected from the same hierarchy image PMj have the same horizontal resolution α and vertical resolution β. In the example in FIG. 6, the accuracy allowance value Pt1 for determining an exclusion feature point is set to 0.35 degrees. In the example in FIG. 6, the vertical resolution β of the hierarchy image PM7 is greater than the accuracy allowance value Pt1. Therefore, the feature point exclusion processing unit 140 selects and excludes all feature points detected in the hierarchy image PM7 as exclusion feature points. Thus, in the first embodiment, the pixel accuracy is the angular resolution per pixel determined for each hierarchy image PMj. If at least one of the horizontal resolution α and the vertical resolution β of the hierarchy image PMj exceeds the accuracy allowance value, all feature points detected from that hierarchy image PMj are selected as the exclusion feature points. In the example in FIG. 6, the accuracy allowance values Pt1 for the horizontal resolution α and the vertical resolution are set to the same value, alternatively, they may be set to different values.

The accuracy allowance value Pt1 may be a fixed value, or it may be changed according to the travel state of the mobile object 10 detected by the travel state detection unit 300. The travel state detection unit 300 detects the traveling speed of the mobile object 10, the position of the mobile object 10 on the map, and the traffic congestion on the travel route of the mobile object 10 as the travel state of the mobile object 10.

### <Setting of Accuracy Allowance Value Pt1 According to Travelling Speed>

The accuracy allowance value Pt1 may be set to a lower value the higher the travel speed of the mobile object 10. In this way, more accurate position estimation can be performed when the mobile object 10 is travelling at high speed. The travelling speed of the mobile object 10 can be acquired from the output of the vehicle speed sensor of the mobile object 10.

### <Setting of Accuracy Allowance Value Pt1 According to Position or Region of the Mobile Object>

The accuracy allowance value Pt1 may be changed according to the position of the mobile object 10 in the map and the region in which the mobile object 10 is traveling. For example, if the mobile object 10 is traveling on an ordinary road, the value may be set lower than if it is traveling on a highway. In this way, highly accurate position estimation can be performed even on an ordinary road where the detection accuracy of feature points is low. On a road with low traffic volume, such as a gravel road, the accuracy allowance value Pt1 may be set to a higher value than on other roads. The position and region of the mobile object 10 in the map can be detected, for example, using a Global Navigation Satellite System (i.e., GNSS) receiver or a navigation device.

### <Setting of Accuracy Allowance Value Pt1 According to Traffic Congestion Condition>

The accuracy allowance value Pt1 may be changed according to the traffic congestion condition of the travel route of the mobile object 10. For example, if there is traffic congestion on the travelling route, the accuracy allowance value Pt1 may be set to a higher value than if there is no traffic congestion. The traffic congestion on the travelling route can be detected, for example, using a wireless communication device that communicates wirelessly with the Intelligent Transport System (i.e., ITS).

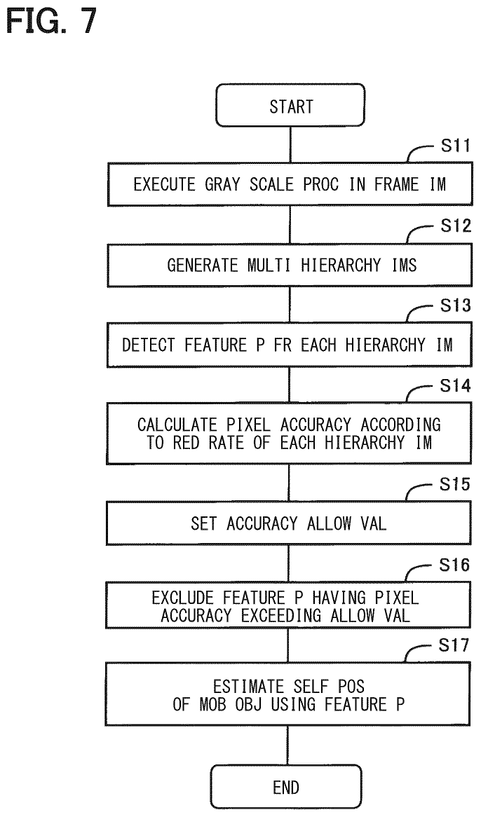

The position estimation process shown in FIG. 7 is performed periodically after the activation of the mobile object 10. In step S11, the grayscale processing unit 110 executes the grayscale processing on the frame image IM0 to generate the process target image IM1. In step S12, the hierarchy image generation unit 120 generates a plurality of hierarchy images PMj, each having the size obtained by reducing the process target image IM1 by a plurality of reduction ratios. In step S13, the feature point detection unit 130 detects the feature points from each hierarchy image PMj. In step S14, the pixel accuracy, which is the accuracy per pixel, is calculated according to the reduction ratio of each hierarchy image PMj. As described above, in the first embodiment, the pixel accuracy is the angular resolution obtained by dividing the view angle of the camera 20 by the number of pixels in the hierarchy image PMj.

In step S15, the allowance value setting unit 150 sets the accuracy allowance value Pt1. As described above, the accuracy allowance value Pt1 may be a fixed value or may be changed according to the travel state of the mobile object 10 detected by the travel state detection unit 300. If the preliminarily set accuracy allowance value Pt1 is used as it is, step S15 is omitted. In step S16, the feature point exclusion processing unit 140 selects and excludes feature points that exceed the accuracy allowance value as the exclusion feature points. As explained in FIG. 6, in the first embodiment, all feature points detected in the hierarchy image PM7 whose pixel accuracy exceeds the accuracy allowance value Pt1 are selected as the exclusion feature points.

In step S17, the self-position estimation unit 200 executes the process of estimating the self-position of the mobile object 10 using the multiple feature points after the feature exclusion process. This self-position estimation process is executed using, for example, the SLAM (i.e., Simultaneous Localization and Mapping) algorithm. The SLAM is an algorithm that simultaneously executes the self position estimation for detecting the self position on the map and an environment map generation for the surrounding environment. Here, the feature point may be used for other processes other than the self-position estimation. For example, the feature point may be used to detect a traffic lane or other mobile object or other objects.

According to the first embodiment described above, since the feature points whose pixel accuracy, which is the accuracy per pixel determined according to the reduction ratio of each hierarchy image PMj, exceeds the allowance value are selected and excluded as the exclusion feature points, only the feature points with high accuracy can be used by excluding the feature points with low accuracy. It is also possible to exclude the feature points that exceed the allowance value from the tracking target over multiple frame images. Furthermore, since the feature points with low accuracy are not handed over to the processing of the self-position estimation unit 200, the scale invariance, the faster processing time, and the improvement of the self-position estimation accuracy can be achieved simultaneously.

### B. Second Embodiment

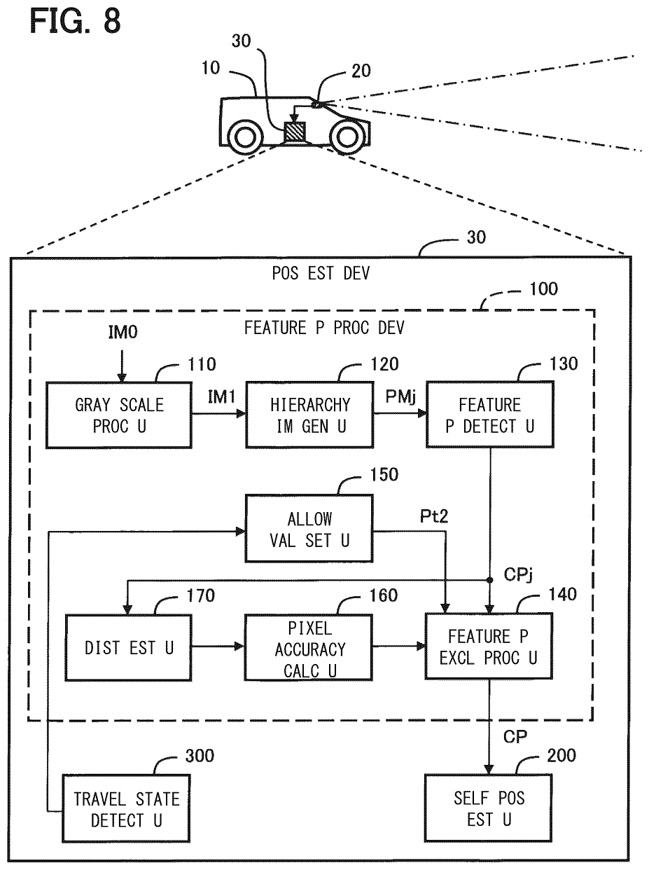

The position estimation unit 30 of the second embodiment shown in FIG. 8 is prepared by adding a distance estimation unit 170 to the feature point processing device 100 in the position estimation device 30 of the first embodiment shown in FIG. 1, and the other configuration of the position estimation unit 30 of the second embodiment is the same as in the first embodiment.

The distance estimation unit 170 estimates the distance from the camera 20 to the three dimensional position of each feature point CP according to the position of each feature point CP in each hierarchy image PMj. The “three dimensional position of the feature point CP” indicates the position of the point in the real world corresponding to feature point CP detected in the hierarchy image PMj. As a method of estimating the distance, one or more of the following methods can be used, for example.

### <Method Based on Road Surface Estimation M1>

A method for estimating the distance from the camera 20 to the three dimensional position of the feature point CP, assuming that the feature point CP is on the road surface.

### <Method Based on Monocular Depth Estimation M2>

A method for estimating the depth (i.e., image depth) of each part in an image from a single image taken by a monocular camera mounted on a mobile object 10. In this method M2, the position of the feature point CP in each hierarchy image PMj and the depth at that position can be used to estimate the distance from the camera 20 to the three dimensional position of the feature point CP.

### <Method Based on Depth Camera M3>

A method for estimating the depth (i.e., image depth) using a Depth camera mounted on a mobile object 10. This method M3 can be used when an RGBD camera is used as the camera 20.

### <Method Based on Stereo Camera M4>

A method of estimating the distance of a feature point CP by triangulation using a stereo camera mounted on a mobile object 10. This method M4 can be used when a stereo camera is used as the camera 20.

### <Method Based on Distance Measurement Device M5>

A method for estimating the distance of a feature point CP using the measurement results of a distance measurement device mounted on a mobile object 10. A millimeter wave radar and LiDAR (i.e., Light Detection And Ranging) can be used as the distance measurement device. In this method M5, the distance from the camera 20 to the three dimensional position of the feature point CP can be estimated using the position of the feature point CP in each hierarchy image PMj and the distance measurement value at the point on the screen of the distance measurement device corresponding to that position.

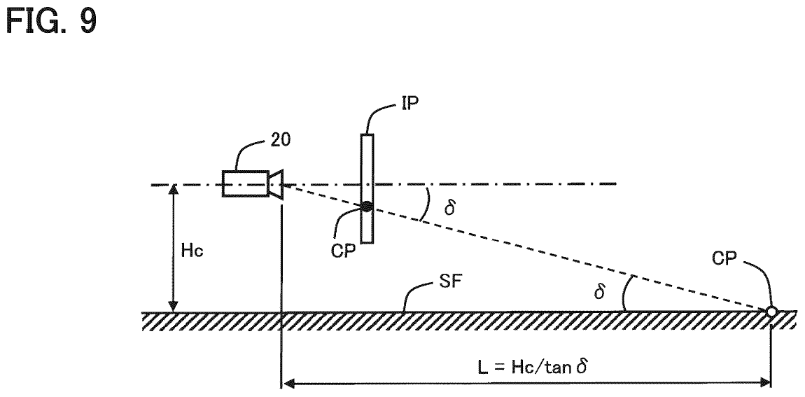

As shown in FIG. 9, in the method M1 based on the road surface estimation, the feature point CP is estimated to be on the road surface SF of the travel route of the mobile object. The distance L from the camera 20 to the feature point CP can be calculated by the following expression, using the depression angle δ determined from the position of the feature point CP in the image plane IP of the camera 20 and the height Hc of the camera 20 from the road surface SF.

$$L = Hc / tan δ \qquad ( q1 )$$

Since the image plane IP of the camera 20 corresponds to the image plane of each hierarchy image PMj, the depression angle δ is determined from the position of the feature point CP in each hierarchy image PMj. Methods other than the method shown in FIG. 9 can be used as the method M1 based on the road surface estimation, for example, a method to estimate the distance L using triangulation with the focal length of the camera 20 can be used.

The distance estimation methods M1 to M5 described above are the same in that they all estimate the distance from the camera 20 to the three dimensional position of the feature point CP according to the position of each feature point CP in each hierarchy image PMj. Other distance estimation methods other than those described above may be used.

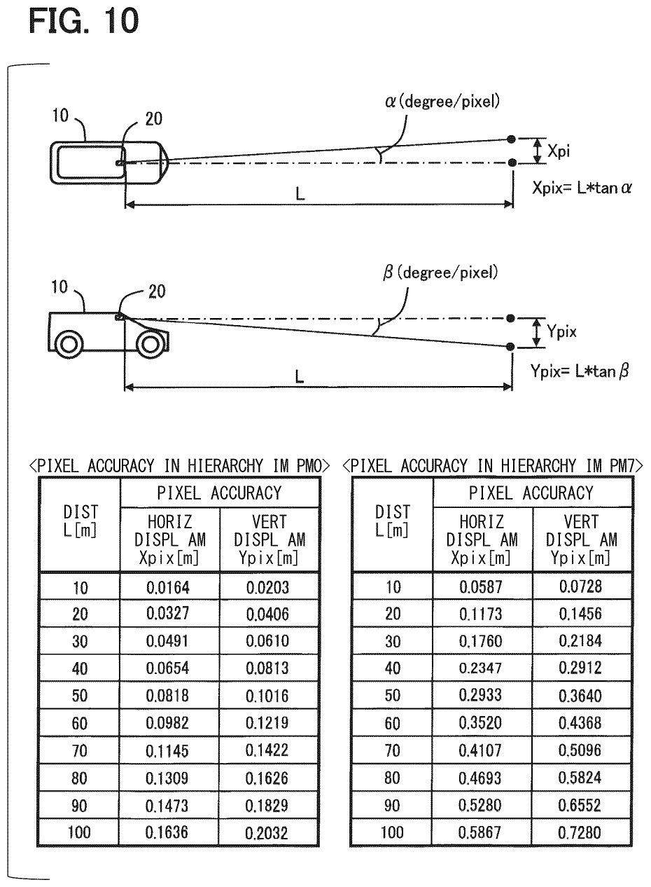

As shown in FIG. 10, in the second embodiment, the pixel accuracy calculation unit 160 calculates the pixel accuracy for each hierarchy image PMj according to the distance L from the camera 20 to the three dimensional position of the feature point CP. The pixel accuracy in the second embodiment is the amount of position displacement per pixel determined by the reduction ratio of each hierarchy image PMj and the distance L of each feature point CP. The unit of the amount of the position displacement [i.e., meter] is the length in real three dimensional space. The amount of horizontal displacement Xpix and the amount of vertical displacement Ypix as the pixel accuracy are calculated by the following expressions, respectively.

$$Xpix = L * tan α \qquad ( q2 )$$

$$Ypix = L * tan β \qquad ( q3 )$$

Here, α is the angular resolution per pixel in the horizontal direction and β is the angular resolution per pixel in the vertical direction.

In FIG. 10, the values of the horizontal displacement Xpix and vertical displacement Ypix according to the distance L are exemplified for the two hierarchy images PM0 and PM7.

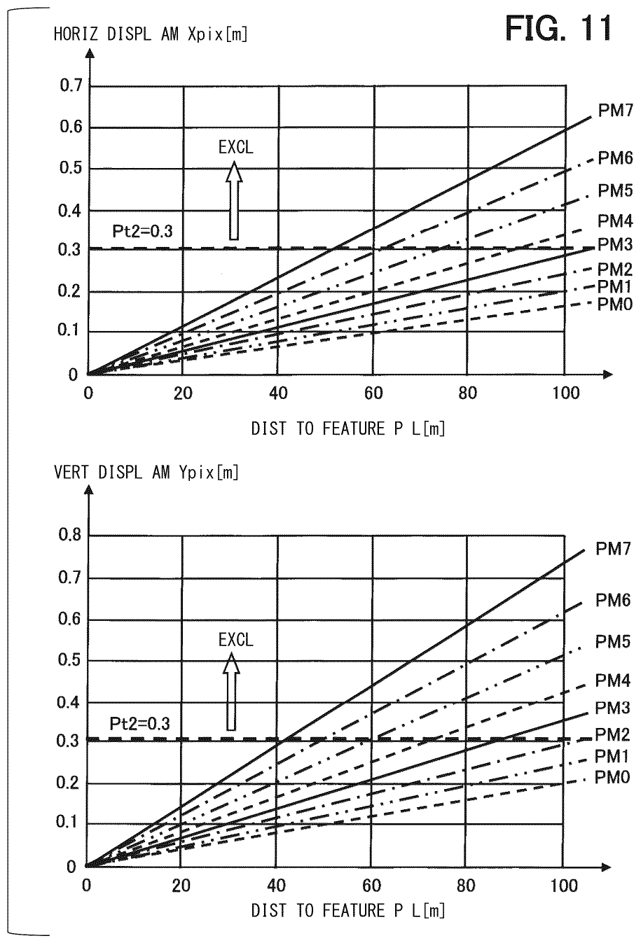

As shown in FIG. 11, the amount of horizontal displacement Xpix and the amount of vertical displacement Ypix as the pixel accuracy are determined for each hierarchy image PMj according to the distance L to the feature point CP. In the example in FIG. 11, the accuracy allowance value Pt2 for determining an exclusion feature point is set to 0.3 meters. For the hierarchy image PM7, when the distance L to the feature point CP is 52 meters or more, the amount of horizontal displacement Xpix exceeds the accuracy allowance value Pt2. The vertical displacement Ypix exceeds the accuracy allowance value Pt2 when the distance L to the feature point CP is 42 meters or more. Therefore, for the hierarchy image PM7, the feature point CP whose distance L is 42 meters or more is selected as an exclusion feature point. Similarly for the other hierarchy images PMj, the feature points CP for which at least one of the horizontal displacement amount Xpix and the vertical displacement amount Ypix exceeds the accuracy allowance value Pt2 are selected as the exclusion feature points.

Similar to the accuracy allowance value Pt1 in the first embodiment, the accuracy allowance value Pt2 may be a fixed value or may be changed according to the travel state of the mobile object 10 detected by the travel state detection unit 300. The accuracy allowance values Pt2 for the horizontal displacement amount Xpix and the vertical displacement amount Ypix may be set to different values.

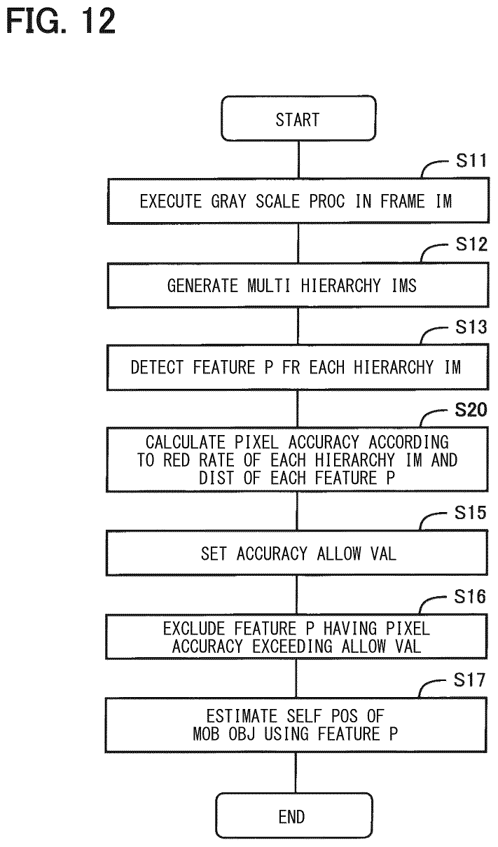

The procedure for the position estimation process shown in FIG. 12 is prepared by replacing step S14 in FIG. 7 with step S20, and the other steps are the same as in the first embodiment. In step S20, the pixel accuracy calculation unit 160 calculates the pixel accuracy according to the reduction ratio of each hierarchy image PMj and the distance L of each feature point CP. The other steps are almost the same as in the first embodiment, so the explanation is omitted.

The second embodiment has the same advantages as those of the first embodiment. In addition, the second embodiment can exclude feature points with low pixel accuracy according to the distance L from the camera 20 to the three dimensional position of the feature point CP.

### C. Third Embodiment

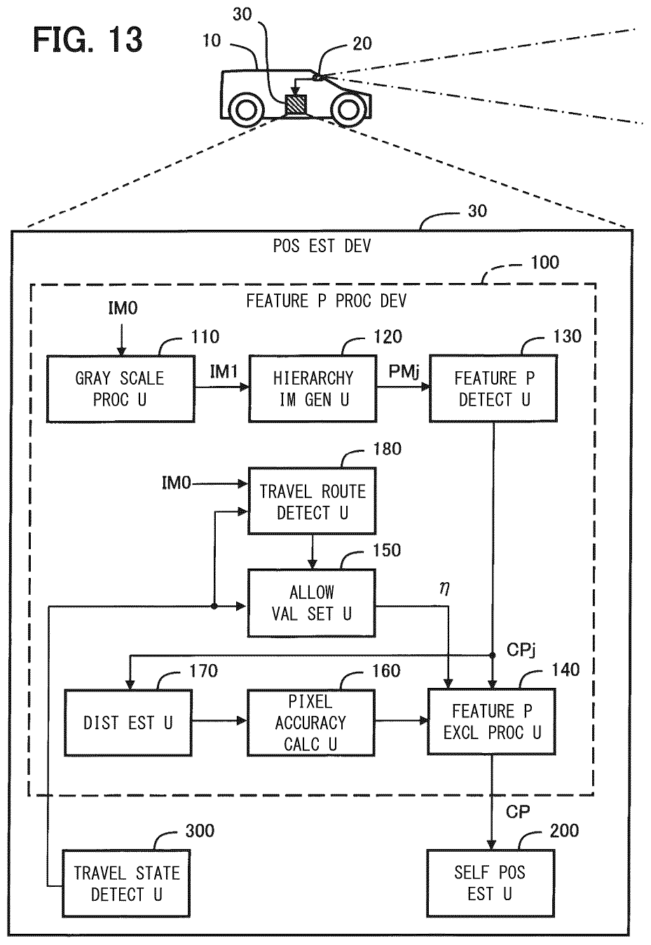

The position estimation unit 30 of the third embodiment shown in FIG. 13 is prepared by adding a travel route detection unit 180 to the feature point processing device 100 in the position estimation device 30 of the second embodiment shown in FIG. 8, and the other configuration of the position estimation unit 30 of the third embodiment is the same as in the second embodiment. The travel route detection unit 180 detects the width of the travel route of the mobile object 10 using the frame image IM0.

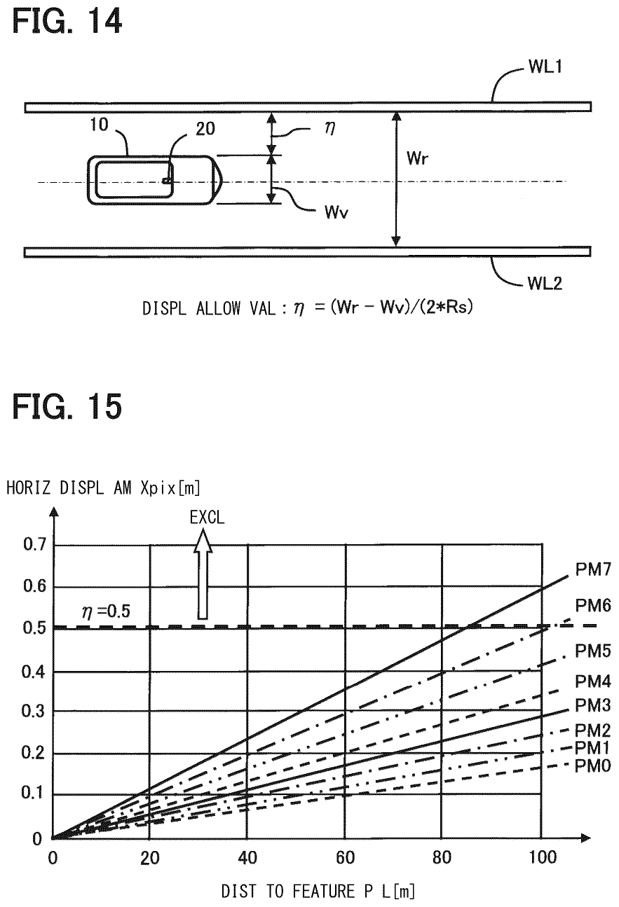

In the example shown in FIG. 14, both sides of the travel route of the mobile object 10 are defined by white lines WL1 and WL2, and the distance between the white lines WL1 and WL2 is detected as the travel route width Wr. Instead of white lines, the shoulder of the travel route may be used to detect the travel route width Wr. The white lines WL1, WL2 and the shoulders can be detected, for example, by detecting feature points on the road surface from the frame image IM0 and estimating a curve extending approximately parallel to the travel direction of the mobile object 10 from among curves connecting those feature points.

The allowance value for pixel accuracy in the third embodiment is the displacement allowance value η, which is dynamically determined according to the difference between the travel route width Wr and the width Wv of the mobile object 10. This displacement allowance value η is calculated, for example, by the following expression.

$$η = ( Wr - Wv ) / ( 2 * Rs ) \qquad ( q4 )$$

Here, Rs is the safety factor and may be set to a value greater than 1.

As can be understood from the above expression (q4), the displacement allowance value η may be proportional to half of the difference between the travel route width Wr and the width Wv of the mobile object 10 that is “(Wr−Wv)/2”. It may be further preferable that the displacement allowance value η is set to a value smaller than “(Wr−Wv)/2”.

As shown in FIG. 15, in the third embodiment, the displacement allowance value η for determining exclusion feature points is set for the amount of the lateral displacement Xpix. On the other hand, the vertical displacement Ypix is not used to select the exclusion feature points. For the hierarchy image PM7, when the distance L to the feature point CP is 85 meters or more, the amount of horizontal displacement Xpix exceeds the displacement allowance value n. Therefore, for the hierarchy image PM7, the feature point CP whose distance L is 85 meters or more is selected as an exclusion feature point. Similarly for the other hierarchy images PMj, the feature points CP whose lateral displacement Xpix exceeds the displacement allowance value η are selected as the exclusion feature points.

The process of dynamically determining the displacement allowance value n for determining the exclusion feature points may be executed when the distribution of pixel values in the process target image IM1 is flat and the number of feature points CP to be detected is equal to or smaller than the threshold number. In general, the smaller the number of feature points CP, the less accurate the estimation of the self-position of the mobile object 10 tends to be. Therefore, when the number of detected feature points CP is equal to or less than the threshold number, it may be preferable to dynamically determine the displacement allowance value η according to the difference between the travel route width Wr and the width Wv of the mobile object 10, so that more feature points can be used for the self-position estimation process. Here, the displacement allowance value η may be dynamically determined regardless of the number of feature points CP.

Whether or not to use the displacement allowance value η may be determined in advance, for example, according to the position or region of the mobile object 10 in the map. That is, it is possible to investigate in advance whether or not the number of detected feature points CP is small for each region where the mobile object 10 may travel, and to determine the displacement allowance value use region according to the results of this investigation.

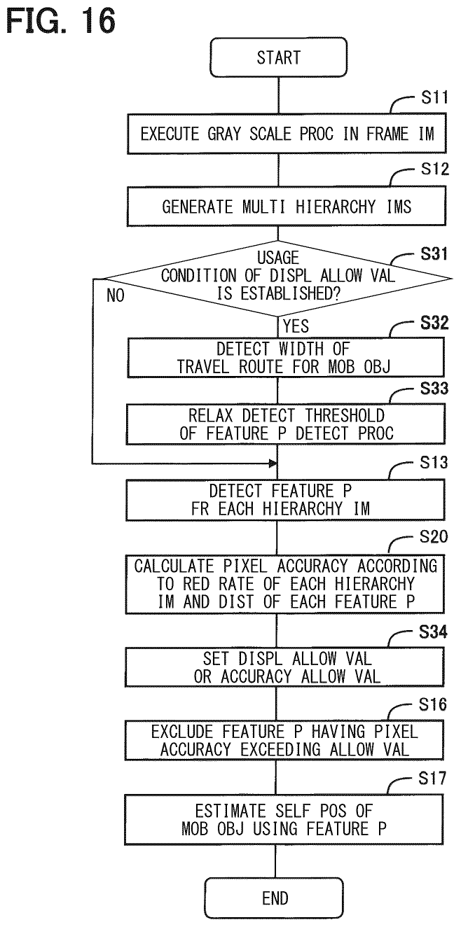

The procedure for the position estimation process shown in FIG. 16 is prepared by adding steps S31 to S33 between steps S12 and S13 and replacing step S15 with step S34 in FIG. 12, and other steps are the same as in the second embodiment.

In step S31, the travel state detection unit 300 determines whether the displacement allowance value use condition is satisfied. For example, if the position of the mobile object 10 on the map is in a predetermined displacement allowance value use region, the displacement allowance value use condition is determined to be satisfied. If the displacement allowance value use condition is not satisfied, steps S32 and S33 are skipped and step S13 is executed. On the other hand, if the displacement allowance value use condition is satisfied, the process proceeds to step S32, where the travel route detection unit 180 detects the travel route width Wr of the mobile object 10. In step S33, the feature point detection unit 130 relaxes the detection threshold for the feature point detection process compared to the case where the displacement allowance value use condition is not satisfied. The relaxed lower detection threshold is used for the feature point detection process in the next step S13. Therefore, more feature points can be detected when the displacement allowance value use condition is satisfied than when the displacement allowance value use condition is not satisfied. Here, step S33 may be omitted.

If the displacement allowance value use condition is satisfied, in step S34, the allowance value setting unit 150 sets the displacement allowance value n according to the difference between the travel route width Wr and the mobile object width Wv, and in step S16, the feature point exclusion processing unit 140 executes the feature point exclusion process using the displacement allowance value n. On the other hand, if displacement allowance value use condition is not satisfied, the same accuracy allowance value Pt2 as in the second embodiment is used and the feature point exclusion process described in FIG. 11 is executed.

The third embodiment also provides the same effects as the first and second embodiments. In addition, since the third embodiment dynamically determines the displacement allowance value η according to the difference between the travel route width Wr and the mobile object width Wv, a large number of feature points can be used according to the travel state of the mobile object 10.

The present disclosure is not limited to the above-described embodiment and its modifications, and can be embodied in various forms without departing from the spirit and scope of the present disclosure.

Reference number 10 indicates a mobile object, reference number 20 indicates a camera, reference number 30 indicates a position estimation unit, reference number 100 indicates a feature point processing unit, reference number 110 indicates a grayscale processing unit, reference number 120 indicates a hierarchy image generation unit, reference number 130 indicates a feature point detection unit, reference number 140 indicates a feature point exclusion processing unit, reference number 150 indicates an allowance value setting unit, reference number 160 indicates a pixel accuracy calculation unit, reference number 170 indicates a distance estimation unit, reference number 180 indicates a travel route detection unit, reference number 200 indicates a self-position estimation unit, and reference number 300 indicates a travel state detection unit.

In the present disclosure, the term “processor” may refer to a single hardware processor or several hardware processors that are configured to execute computer program code (i.e., one or more instructions of a program). In other words, a processor may be one or more programmable hardware devices. For instance, a processor may be a general-purpose or embedded processor and include, but not necessarily limited to, CPU (a Central Processing Circuit), a microprocessor, a microcontroller, and PLD (a Programmable Logic Device) such as FPGA (a Field Programmable Gate Array).

The term “memory” in the present disclosure may refer to a single or several hardware memory configured to store computer program code (i.e., one or more instructions of a program) and/or data accessible by a processor. A memory may be implemented using any suitable memory technology, such as static random-access memory (SRAM), synchronous dynamic RAM (SDRAM), nonvolatile/Flash-type memory, or any other type of memory. Computer program code may be stored on the memory and, when executed by a processor, cause the processor to perform the above-described various functions.

In the present disclosure, the term “circuit” may refer to a single hardware logical circuit or several hardware logical circuits (in other words, “circuitry”) that are configured to perform one or more functions. In other words (and in contrast to the term “processor”), the term “circuit” refers to one or more non-programmable circuits. For instance, a circuit may be IC (an Integrated Circuit) such as ASIC (an application-specific integrated circuit) and any other types of non-programmable circuits.

In the present disclosure, the phrase “at least one of (i) a circuit and (ii) a processor” should be understood as disjunctive (logical disjunction) where the circuit and the processor can be optional and not be construed to mean “at least one of a circuit and at least one of a processor”. Therefore, in the present disclosure, the phrase “at least one of a circuit and a processor is configured to cause a feature point processing device to perform functions” should be understood that (i) only the circuit can cause a feature point processing device to perform all the functions, (ii) only the processor can cause a feature point processing device to perform all the functions, or (iii) the circuit can cause a feature point processing device to perform at least one of the functions and the processor can cause a feature point processing device to perform the remaining functions. For instance, in the case of the above-described (iii), function A and B among the functions A to C may be implemented by a circuit, while the remaining function C may be implemented by a processor.

It is noted that a flowchart or the processing of the flowchart in the present application includes sections (also referred to as steps), each of which is represented, for instance, as S11. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A feature point processing device comprising:
a hierarchy image generation unit that generates a plurality of hierarchy images having sizes that are obtained by reducing a process target image by a plurality of reduction ratios using the process target image acquired by a camera mounted on a mobile object;
a feature point detection unit that executes a feature point detection process to detect a plurality of feature points from the plurality of hierarchy images; and
a feature point exclusion processing unit that selects and excludes some of the plurality of feature points as an exclusion feature point, wherein:
the feature point exclusion processing unit selects, among the plurality of feature points, one of the feature points having a pixel accuracy exceeding an allowance value as the exclusion feature point; and
the pixel accuracy is an accuracy per pixel determined according to the reduction ratio of each hierarchy image.

2. The feature point processing device according to claim 1, wherein:
the pixel accuracy is an angular resolution per pixel determined for each of the plurality of hierarchy images; and
the feature point exclusion processing unit selects all of feature points that are detected in the hierarchy image and have the pixel accuracy exceeding the allowance value as the exclusion feature point.

3. The feature point processing device according to claim 1, further comprising:
a distance estimation unit that estimates a distance from the camera to a three dimensional position of each feature point according to a position of each feature point in each hierarchy image, wherein:
the pixel accuracy is an amount of position displacement per pixel determined according to the reduction ratio of each hierarchy image and the distance of each feature point.

4. The feature point processing device according to claim 3, further comprising:
a travel route detection unit that detects a width of a travel route of the mobile object from the process target image, wherein:
the allowance value is a displacement allowance value dynamically determined according to a difference between the width of the travel route and a width of the mobile object.

5. The feature point processing device according to claim 3, further comprising:
at least one of (i) a circuit and (ii) a processor having a memory storing computer program code,
wherein the at least one of the circuit and the processor having the memory is configured to cause the feature point processing device to provide at least one of: the hierarchy image generation unit; the feature point detection unit; and the feature point exclusion processing unit.

6. A feature point processing device comprising:
at least one of (i) a circuit and (ii) a processor having a memory storing computer program code,
wherein the at least one of the circuit and the processor having the memory is configured to cause the feature point processing device to execute:
generating a plurality of hierarchy images having sizes that are obtained by reducing a process target image by a plurality of reduction ratios using the process target image acquired by a camera mounted on a mobile object;
executing a feature point detection process to detect a plurality of feature points from the plurality of hierarchy images; and
selecting and excluding some of the plurality of feature points as an exclusion feature point, wherein:
the selecting and excluding of the some of the plurality of feature points includes to select, among the plurality of feature points, one of the feature points having a pixel accuracy exceeding an allowance value as the exclusion feature point; and
the pixel accuracy is an accuracy per pixel determined according to the reduction ratio of each hierarchy image.

7. A feature point processing method comprising:
generating a plurality of hierarchy images having sizes that are obtained by reducing a process target image by a plurality of reduction ratios using the process target image acquired by a camera mounted on a mobile object;
executing a feature point detection process to detect a plurality of feature points from the plurality of hierarchy images; and
selecting and excluding some of the plurality of feature points as an exclusion feature point, wherein:
the selecting and excluding of the some of the plurality of feature points includes selecting, among the plurality of feature points, one of the feature points having a pixel accuracy exceeding an allowance value as the exclusion feature point; and
the pixel accuracy is an accuracy per pixel determined according to the reduction ratio of each hierarchy image.
